(19) United States
(12) Patent Application Publication
(10) Pub. No.: US 2025/0039558 A1
(43) Pub. Date: Jan. 30, 2025

(54) ELECTRONIC DEVICE

(71) Applicant: SONY SEMICONDUCTOR SOLUTIONS CORPORATION, KANAGAWA (JP)

(72) Inventors: MASASHI NAKATA, KANAGAWA (JP); AKIO UNNO, KANAGAWA (JP)

(21) Appl. No.: 18/715,981

(22) PCT Filed: Nov. 7, 2022
(86) PCT No.: PCT/JP2022/041427

§ 371 Date: Jun. 3, 2024

(30) Foreign Application Priority Data
Dec. 10, 2021 (JP) 2021-201010

(51) Int. Cl. H04N 23/76; H04N 9/64; H04N 23/53; H04N 23/67; H04N 25/61

(52) U.S. Cl. CPC H04N 23/76; H04N 9/646; H04N 23/53; H04N 23/67; H04N 25/61

(57) ABSTRACT

An image signal is corrected on the basis of an output from a sensor or a driver. An electronic device includes a display surface, an imaging element, and a processing circuit. The display surface displays information on the basis of light emitted from the light emitting element. The imaging element is disposed on an opposite side of the display surface. The processing circuit processes a signal output from the imaging element. More specifically, the processing circuit acquires data not caused by the imaging element, and corrects an image signal received and output by the imaging element using the acquired data not caused by the imaging element.

### TECHNICAL FIELD

The present disclosure relates to an electronic device.

### BACKGROUND ART

In a terminal device such as a smartphone, it is desired to reduce a bezel width, and it is considered that a camera module is disposed below a display in response to such a demand. In a case where the camera module is provided below the display, a subject is imaged through the display. At this time, if an attempt is made to image a region including a light source with high luminance through the display, flare due to diffraction of the display becomes a major problem.

Furthermore, in a case where imaging is used while a shadow image is displayed on the display, light emitted from a display surface may also directly or indirectly enter an imaging element side. In order to avoid this, conventionally, control has been performed such that a part of the display provided with a camera is darkly displayed at a timing of imaging with the camera. In such control, since a part of a display is displayed dark, by arranging the camera at a position close to the center of the display, a part close to the center of the image becomes dark, and deterioration of the image increases. On the other hand, in a case where a video call is made or the like, there arises a problem that it is desired to arrange the position of the camera closer to the center of the display.

### CITATION LIST

### Patent Document

Patent Document 1: WO 2021/111955

### SUMMARY OF THE INVENTION

### Problems to be Solved by the Invention

Therefore, the present disclosure provides an electronic device that corrects an image signal on the basis of an output from a sensor or a driver and suppresses various image deterioration.

### Solutions to Problems

According to an embodiment, an electronic device includes a display surface, an imaging element, and a processing circuit. The display surface displays information on the basis of light emitted from the light emitting element. The imaging element is disposed on an opposite side of the display surface. The processing circuit processes a signal output from the imaging element. More specifically, the processing circuit acquires data not caused by the imaging element, and corrects an image signal received and output by the imaging element using the acquired data not caused by the imaging element.

The data not caused by the imaging element may be data caused by the display surface.

The data caused by the display surface may be caused by light emitted from the light emitting element.

The data caused by the display surface may be caused by at least one of diffraction or reflection on the display surface or light emitted from the light emitting element and directly reaching the imaging element.

The data caused by the display surface may be caused by light incident on the display surface.

The data caused by the display surface may be caused by flare of light incident from an outside on the display surface.

The electronic device may further include a focus driver that controls the focus. In this case, the processing circuit may correct the image signal on the basis of information acquired by the focus driver.

The processing circuit may acquire imaging information in a proximity focus acquired by the focus driver, and correct the image signal with the image signal displayed in proximity as a correction target on the basis of the imaging information in the proximity focus.

The processing circuit may correct the image information focused on an external subject on the basis of imaging information in the proximity focus.

The processing circuit may acquire a display signal to be displayed through the display surface, and correct the image signal on the basis of the display signal.

The processing circuit may acquire the display signal from a display driver that controls the light emitting element, or may acquire the display signal input from the outside to correct the image signal.

The processing circuit may correct the image signal on the basis of a signal in which resolution of the display signal is reduced.

The electronic device may further include a gyro sensor. In this case, the processing circuit may correct the image signal on the basis of a gyro signal output from the gyro sensor.

The processing circuit may use an image without camera shake as a display signal on the basis of the gyro signal, and correct the image signal on the basis of the display signal.

The processing circuit may estimate a positional relationship between an external subject and the imaging element on the basis of the gyro signal, and correct the image signal from a change in data acquired by the imaging element for a pixel for which an accurate pixel value cannot be acquired in a single frame.

The pixel in which the accurate pixel value has not been acquired may be a pixel in which a signal output from the pixel is saturated.

The correction processing may include correction processing related to a color of the image signal.

The color correction processing may be correction processing at a linear matrix application timing, correction processing at a conversion timing to a YUV signal, or correction processing in color conversion using an LUT.

The correction processing may further include correction processing related to at least one of automatic white balance control, automatic exposure control, or automatic focus control.

The imaging element may be arranged such that a positional relationship with the display surface changes, and the processing circuit may correct the image signal on the basis of the positional relationship between the display surface and the imaging element along time series.

The processing circuit may acquire a shape change in the image signal with the lapse of time, and correct the image information on the basis of the shape change.

The processing circuit may correct the image information using a learned model.

The learned model may be a model learned by using a display signal and the image signal as teacher data.

### BRIEF DESCRIPTION OF DRAWINGS

FIG. 1 is an external view schematically illustrating an electronic device according to an embodiment.

FIG. 2 is a block diagram schematically illustrating a configuration of the electronic device according to the embodiment.

FIG. 3 is a diagram illustrating an example of a display and an arrangement of an imaging element according to the embodiment.

FIG. 4 is a diagram illustrating an example of occurrence of image degradation caused by an inside.

FIG. 5 is a diagram illustrating an example of occurrence of image degradation caused by the inside.

FIG. 6 is a diagram illustrating an example of occurrence of image degradation caused by the inside.

FIG. 7 is a diagram illustrating an example of occurrence of image degradation caused by the inside.

FIG. 8 is a diagram illustrating an example of occurrence of image degradation caused by the inside.

FIG. 9 is a diagram illustrating an example of occurrence of image degradation caused by the inside.

FIG. 10 is a flowchart illustrating an example of processing of a processing circuit according to the embodiment.

### MODE FOR CARRYING OUT THE INVENTION

Hereinafter, embodiments of the present disclosure will be described with reference to the drawings. The drawings are used for description, and the shape and size of the configuration of each unit in the actual device, the ratio of size to other configurations, and the like are not necessarily as illustrated in the drawings. Furthermore, since the drawings are illustrated in a simplified manner, configurations necessary for implementation other than those illustrated in the drawings are appropriately provided.

Note that, in the following description, a signal to be processed may be described as image information or imaging information, but the image information or imaging information is a concept in a broad sense, and is a concept including an image of one frame in a still image, a moving image, or a shadow image. In addition, the expressions “larger” and “smaller” can be appropriately read mutually as “greater than or equal to” and “less than or equal to”.

In addition, in a case where the same timing is described, it is not necessary to be exactly the same moment, and it is to be understood as a timing regarded as the same or a timing slightly shifted in time within a certain time range. This representation may vary in this certain range of times as appropriate depending on the context in which it is used. A certain range of time may be, for example, ˜10 msec or ˜33 msec. The range is not limited thereto, and may be shorter or longer.

In the present disclosure, it may be described as “time series data” or “time series data”, but this expression does not exclude data of one frame. That is, the time-series data may be data of a plurality of frames along the time series, or may be data of one frame.

### First Embodiment

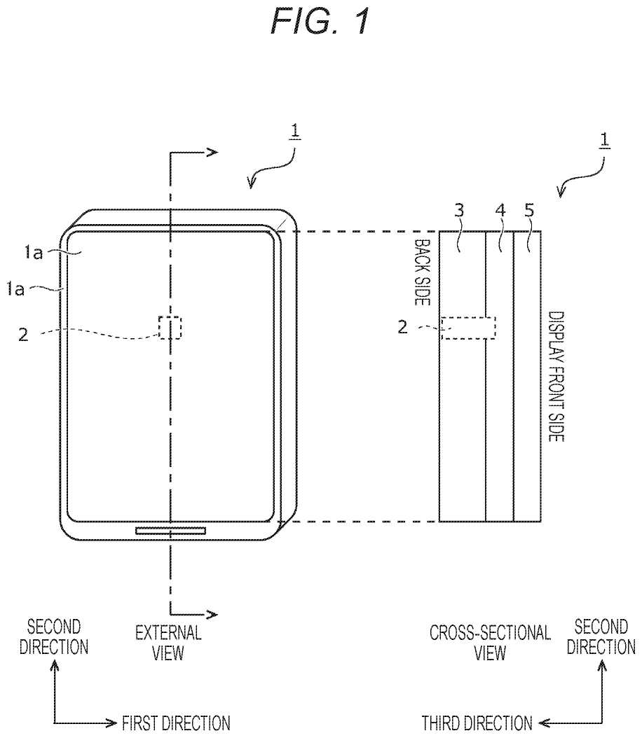

FIG. 1 is an external view and a cross-sectional view schematically illustrating an electronic device according to an embodiment. The electronic device 1 is any electronic device having both a display function and an imaging function, for example, such as a smartphone, a mobile phone, a tablet terminal, or a PC. The electronic device 1 is not limited to these examples, and may be another device, for example, such as an imaging device, a medical device, or an inspection device. The electronic device 1 includes an imaging element 2, a component layer 3, a display 4, and a cover glass 5.

As illustrated in the drawings, a first direction, a second direction that intersects with the first direction, and a third direction that intersects with both the first direction and the second direction are defined for convenience. Angles formed by these directions may be 90 degrees.

The electronic device 1 includes, for example, a display area 1a and a bezel 1b as illustrated in an external view. The electronic device 1 displays an image and a video in the display area 1a. The bezel 1b is sometimes provided with a so-called in-camera in order to acquire an image on a display surface side, but nowadays, it is often required to narrow an area occupied by the bezel 1b. Therefore, the electronic device 1 according to the present embodiment includes an imaging element 2 on a lower side of the display, and the bezel 1b narrows an area closed on the display surface side.

The imaging element 2 includes a light receiving element and a signal processing circuit (hereinafter, referred to as processing circuit) that executes signal processing on a signal output from the light receiving element. The imaging element 2 acquires information regarding an image of a subject on the basis of light received by the light receiving element. In the present specification, unless otherwise noted, it is assumed that the subject is a concept including a simple scene or the like. Details of the imaging element 2 will be described later. Note that, in the drawing, the imaging element 2 has a rectangular shape, but is not limited thereto, and may have any shape such as a circular shape.

The component layer 3 is a layer to which the imaging element 2 belongs. The component layer 3 includes, for example, various modules and devices for realizing processing other than imaging in the electronic device 1. Note that another processing circuit that processes information output from the imaging element 2 or controls the imaging element 2 from the outside may be provided outside the processing circuit in the imaging element 2.

The display 4 is a display that outputs an image, a shadow image, and the like. As illustrated in the cross-sectional view, the display 4 includes the imaging element 2 and the component layer 3 on a back surface side thereof. As illustrated in this cross-sectional view, the imaging element 2 is provided so as to be embedded in the display 4.

The display 4 may be made of, for example, a material containing a material that absorbs light in a wavelength region of 450 nm or less due to its properties. The material that absorbs light in a wavelength region of 450 nm or less is, for example, polyimide. Since polyimide is a material that absorbs light in a wavelength region of 450 nm or less, that is, a blue wavelength region, if the imaging element 2 is embedded in the display 4, it may be difficult for the imaging element 2 to receive light in the blue region. Therefore, the imaging element 2 may have a form in which the intensity of blue light can be appropriately acquired.

The cover glass 5 is a glass layer that protects the display 4. A polarizing phase may be provided between the display 4 and the cover glass 5 so that the light output from the display 4 can be appropriately easily viewed by a user, or an arbitrary layer or the like may be provided in an arbitrary form so that the display area 1a can be used as a touch panel.

In the following description, specific mounting of a light receiving element, a lens, a circuit, and the like in a semiconductor layer and the like is not an essential configuration of the present disclosure and thus will not be described, but can be mounted using an arbitrary method in a shape, a configuration, and the like that can be read from the drawings, the description, and the like. For example, control of the imaging element, acquisition of a signal, and the like can be realized by any method, algorithm, or semiconductor configuration unless otherwise specified.

As illustrated in FIG. 1, the imaging element 2 is provided so as to be embedded in the display 4. Therefore, light incident from a display front side of the electronic device 1 is reflected or diffracted by the cover glass 5 or the display 4. When a light source with high illuminance is present in the imaging area, flare occurs due to this diffraction phenomenon or the like.

Furthermore, light emitted from the light emitting element of the display 4 may directly enter the imaging element 2 or indirectly enter the imaging element 2 by reflection or diffraction on the display 4 or the cover glass 5. In the present embodiment, the processing circuit corrects image degradation caused by the display 4 or the cover glass 5.

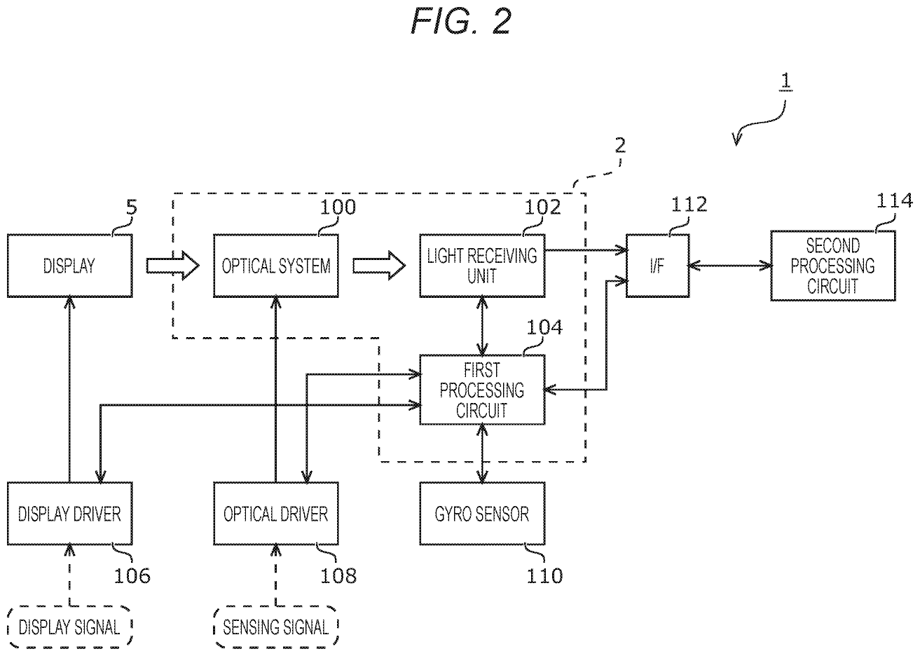

FIG. 2 is a block diagram schematically illustrating a configuration of an electronic device according to an embodiment. The electronic device 1 includes, for example, a display 4, an optical system 100, a light receiving unit 102, a first processing circuit 104, a display driver 106, an optical driver 108, a gyro sensor 110, an interface 112, and a second processing circuit 114.

For example, at least a part of the optical system 100, the light receiving unit 102, and the first processing circuit 104 may be provided as a part of the imaging element 2 or may be provided separately. In the case of being provided as a part of the imaging element 2, these components may be provided on one semiconductor substrate, or may be provided on a semiconductor substrate obtained by laminating two or more semiconductor substrates by any appropriate method. That is, the imaging element 2 may be configured as a one-chip semiconductor including the first processing circuit 104 together with a light receiving element such as a photodiode. In this case, the image signal can be corrected in the semiconductor chip configuring the imaging element 2.

The optical system 100 is an optical system for appropriately condensing light incident through the display 4 on the light receiving unit 102. The light receiving unit 102 includes, for example, a light receiving element such as a photodiode, and outputs an analog signal based on the intensity of light incident on the light receiving element.

In the light receiving unit 102, light receiving pixels including light receiving elements are arranged in a two-dimensional array, and an analog signal based on the intensity of light sensed by each light receiving element is output through a light receiving pixel circuit. The transfer of the signal from the light receiving unit 102 to the first processing circuit 104 is executed according to an arbitrary method.

The first processing circuit 104 is a circuit that converts an analog signal output from the light receiving unit 102 into a digital signal and executes various types of information processing on the converted signal or using the converted signal. The first processing circuit 104 may control various components related to imaging of the electronic device 1. The first processing circuit 104 may control the sensor or the driver on the basis of, for example, a signal acquired from the sensor or a signal acquired from the driver.

In addition, the first processing circuit 104 may receive signals from various components, and correct the image signal output from the light receiving unit 102 and converted on the basis of the received signals. This correction processing will be described in detail later.

The display driver 106 is a driver that drives the display 4. For example, the display 4 emits light from a light emitting pixel including a light emitting element on the basis of information acquired from the display driver 106, and forms and displays appropriate image information. For example, as indicated by a broken line, the display driver 106 receives a signal of an image to be displayed, and controls the light emitting element so that the image is displayed on the display 4 on the basis of the signal. Note that a control signal may be received from the first processing circuit 104 or the second processing circuit 114.

The optical driver 108 is a driver that controls the optical system 100. The optical driver 108 causes the optical system 100 to execute automatic exposure control and automatic focus control on the basis of, for example, a sensing signal from an illuminance sensor or blurring of an image acquired from an inter-frame image. In addition, for example, the optical driver 108 may transmit a sensing signal from the illuminance sensor to the first processing circuit 104 for automatic white balance control of the image. As described above, the optical driver 108 may include, for example, a focus driver, an exposure driver, or also output a signal for performing white balance control. In addition, the optical driver 108 is a driver that executes processing related to the optical system 100.

The gyro sensor 110 is a sensor that acquires the inclination of the light receiving unit 102 in the electronic device 1. In addition, an acceleration sensor may be provided together with the gyro sensor 110. For example, the gyro sensor 110 may acquire the inclination of the light receiving unit 102 with respect to the electronic device 1. As another example, the gyro sensor 110 may acquire, for example, a change in posture of the electronic device 1 itself as an angular velocity. That is, the gyro sensor 110 is a sensor that acquires at least one of the posture of the electronic device 1 itself and the posture of the light receiving unit 102 with respect to the housing of the electronic device 1. For example, the first processing circuit 104 may be configured to execute camera shake control or the like on the basis of a signal output from the gyro sensor 110.

The interface 112 is an interface that connects the imaging element 2 and the outside. The interface 112 may be, for example, a mobile industry processor interface (MIPI, Registered trademark), a universal serial bus (USB, Registered Trademark), a high-definition multimedia interface (HDMI, Registered trademark), or the like, and may be any interface capable of appropriately transferring an image signal.

The second processing circuit 114 is a processing circuit provided outside the imaging element 2. In a case where the first processing circuit 104 is provided inside the imaging element 2, there is a case where the first processing circuit 104 cannot exhibit sufficient calculation performance due to an installation area of the circuit or the like. In such a case, data can be transferred to the second processing circuit 114 through the interface 112 to perform processing. As described above, the second processing circuit 114 having higher performance than the first processing circuit 104 may be provided. For example, the second processing circuit 114 may control the operation of the electronic device 1 other than the imaging element 2. For example, the display signal input to the display driver 106 may be generated by the second processing circuit 114 and transmitted to the display driver 106.

With use of the electronic device 1 configured as described above, in the present embodiment, processing of correcting deterioration of an acquired image in a case where an imaging element such as a camera module is disposed below a display is realized.

Specifically, the first processing circuit 104 may acquire data (time series data may be used) not caused by the imaging element 2 and correct the image signal output from the imaging element 2 on the basis of the data. The data not caused by the imaging element 2 may be, for example, data acquired from at least one of the display driver 106, the optical driver 108, or the gyro sensor 110.

For example, the electronic device 1 may acquire data caused by the display surface of the display 4 as data output from a sensor or the like provided. The data caused by the display surface may be caused by light emitted from the light emitting element of the display 4.

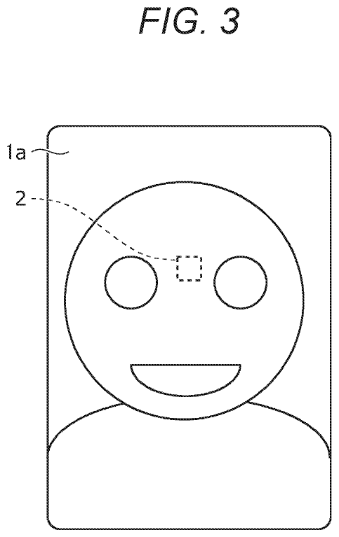

FIG. 3 is a diagram illustrating an example of display according to an embodiment and an example of arrangement of the imaging element 2. For example, an image of a person is displayed in the display area 1a on the display 4. The imaging element 2 is provided under a display corresponding to a face of the person.

In the case where such display is performed, there is a high possibility that light of a skin color of the person displayed on the display 4 enters the imaging element 2. Light of skin color reflected or diffracted by the cover glass 5 on the display surface side or the components of the display 4, or light from the light emitting element of the display 4 directly enters the imaging element 2. As a result, due to this light, the captured image is degraded to a color that approaches the skin color as a whole. Simply, since light of weak intensity close to the skin color is incident on the imaging element, information obtained by mixing the light of weak intensity with information of an original imaging target is acquired by the imaging element 2.

Since a factor of the light caused by the skin color is the image displayed on the display 4, the electronic device 1 can acquire the factor of the light. In order to correct the deteriorated image, the first processing circuit 104 may acquire data of an image to be displayed on the display 4 from the display driver 106, for example.

Hereinafter, a signal related to an image to be displayed acquired by the first processing circuit 104 from the display driver 106 may be referred to as a display signal. Furthermore, an analog signal acquired and output by the imaging element 2 or a signal digitally converted by the first processing circuit 104 is referred to as an image signal.

As a non-limiting example, the first processing circuit 104 may correct the image signal by obtaining a statistic of the display signal acquired from the display driver 106. For example, the first processing circuit 104 may multiply an average value of the display signal acquired from the display driver 106 by a coefficient and subtract the multiplied value from the image signal. In addition, time series data may be acquired from the display driver 106, and correction may be performed with reference to a display signal of a past frame corresponding to at least one frame.

As a non-limiting example, the first processing circuit 104 may acquire a pixel value of a display signal of an area in which the imaging element 2 exists below among the display signals acquired from the display driver 106, and correct the image signal using a value based on the pixel value. In this case, the first processing circuit 104 may correct the image signal by obtaining the statistic of the pixel values of the display signal in this area. As another example, the image signal may be corrected on the basis of the pixel value of the display signal displayed on the display 4 on the display surface side for each light receiving pixel. The correction may be subtraction or the like as described above.

In these examples, for example, imaging may be executed in a case where there is a display signal as a ground image and in a case where there is no display signal, and a degree of influence on the image signal may be statistically obtained. The capturing of the ground image may be executed, for example, in a situation where light from the outside does not enter the entire surface on the display surface side of the display 4.

As a non-limiting example, the image signal may be corrected using a model (learned model) in which parameters are optimized by machine learning after preparing the teacher data. For example, a storage circuit inside or outside the electronic device 1 acquires data of a captured image of a subject in a case where the subject is not displayed on the display 4 and a captured image of a subject in a case where various displays are performed on the display 4.

The image data displayed in some way on the display 4 is input on the basis of the acquired data, and then the model is learned so as to output image data in a case where the image data is not displayed on the display 4. The structure of the model may be any structure, and the learning method of the model may be any learning method (including deep learning).

For example, the model may be a multi-layer perceptron (MLP), a convolutional neural network (CNN), or another neural network model. Furthermore, the model may be another statistical model. For example, the model may be learned by using the image data in a case where the image data is displayed on the display 4 and the image data in a case where the image data is not displayed on the display 4 as the input data and using the image data in a case where the image data is not displayed on the display 4 as the output data.

Furthermore, as another example, a display signal acquired from the display driver 106 and an image signal acquired from the imaging element 2 are input to the model, and then the model may be optimized such that an image signal in a case where there is no display signal is output.

Parameters of a learned model are stored in a storage circuit (not illustrated) in the electronic device 1, and the first processing circuit 104 appropriately configures a model from the parameters. In a case where the image signal is acquired at the timing when the display signal can be acquired from the display driver 106, the first processing circuit 104 may correct the image by inputting the display signal and the image signal.

As another example of using the model, display signals of a plurality of frames can be used. For example, in learning, a model in which deterioration of a current frame is corrected when display signals of a plurality of frames are input may be formed. A display signal and an image signal of a plurality of frames may be input. With such learning, the first processing circuit 104 can appropriately correct the image signal acquired from the imaging element 2 even in a case where an image or the like is displayed on the display 4.

As another example, the first processing circuit 104 may directly acquire the display signal from, for example, an external module such as the second processing circuit 114 without passing through the display driver 106.

Furthermore, in each of the above examples (in either rule based or machine learning based), the data used for correction may be data in which the resolution of the display signal is reduced. This is because an area of the imaging element 2 is sufficiently small as compared with a size of the display area 1a, and there is a possibility that information of a display image having a fine granularity is not so necessary for correction of an image signal acquired by the imaging element 2.

As described above, according to the present embodiment, the signal displayed on the display 4 is acquired, so that the first processing circuit 104 can correct the image signal that suppresses the influence of the light from the light emitting element of the display 4. Note that, in the present embodiment, the optical driver 108 and the gyro sensor 110 are not essential components, but it is of course possible to perform the correction processing decoded from the embodiments described later.

### Second Embodiment

In the present embodiment, a description will be given of performing correction processing using data based on a focus position. For example, correction processing in a case where flare caused by light incident on the display surface from the outside occurs will be described. In the following drawings, unlike FIG. 3, a drawing illustrated on a display area 1a is image information acquired by an imaging element 2.

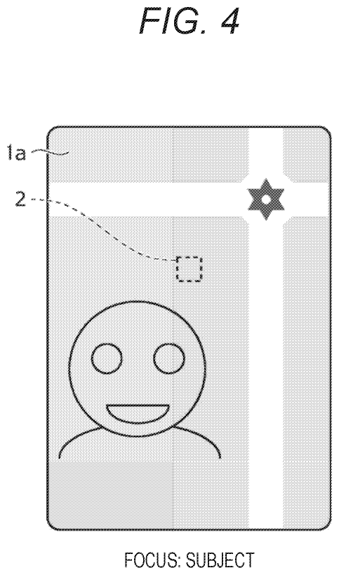

FIG. 4 is a diagram illustrating an example of occurrence of flare in a case where a strong light source is in an imaging region. A white portion in the display area 1a represents flare. In this drawing, the imaging element 2 is adjusted by an optical system 100 so that the subject is focused. The focus is controlled by an optical driver 108, more specifically, the focus driver. The focus driver controls the focus by, for example, changing the position of the lens or changing the shape of the lens.

For example, the focus driver acquires information for autofocus, and controls optical system 100 to automatically focus on a subject. The autofocus may be a contrast method, a phase difference method, or an image plane phase difference method. In the case of using the image plane phase difference, a pixel for acquiring the image plane phase difference may be arranged in the imaging pixel of the imaging element 2.

A first processing circuit 104 may acquire data from this focus driver to correct image degradation due to flare. For example, the focus driver controls the optical system 100 so as to focus closest.

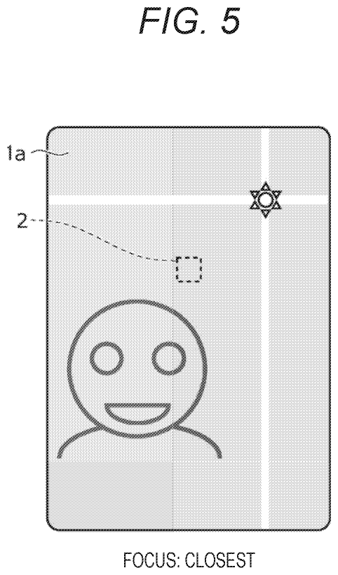

FIG. 5 is a diagram illustrating an example of a captured image in the same situation as in FIG. 4 in a case where the focus is set to the closest distance. The flare is generated due to diffraction and reflection on a cover glass 5 and a display 4. Therefore, in a case where the focus is matched with the cover glass 5 or the display 4, the focus is matched with the flare.

Therefore, the focus driver can control the optical system 100 so that an image in a state where a flare range is small can be acquired by focusing on the cover glass 5 or the like. Although it is desirable to focus on the cover glass 5 or the display 4, it may be difficult to perform such focusing due to restrictions such as the size of an electronic device 1. For this reason, the focus driver controls the optical system 100 so as to adjust the focus to the closest distance, thereby reducing the influence of flare as much as possible.

The focus driver may transmit the image acquired in this state to the first processing circuit 104. The first processing circuit 104 may execute correction processing of the image signal on the basis of the captured image in the state where the focus is on the closest distance acquired by the focus driver.

For example, the first processing circuit 104 executes the correction processing on the image signal focused on the subject by using the captured image focused on the closest distance acquired by the focus driver. With performance of the processing in this manner, the first processing circuit 104 can set a cause of image quality degradation in a region close to the imaging element 2 on the display surface side, such as caused by the cover glass 5 or the display 4, as a correction target.

In the imaging information focused on the proximity, it is possible to remove the flare as described above. As a specific example, the first processing circuit 104 corrects a flare portion of the image focused on the subject as illustrated in FIG. 4 by using the closest focused information as illustrated in FIG. 5. For example, in a case where there is a non-flare region in the signal focused closest to the subject in the flare region in the image information focused on the subject, the first processing circuit 104 may set the pixel value of the non-flare region as the pixel value in the image information focused on the subject.

In addition, the first processing circuit 104 may perform correction for removing flare in the closest focused signal acquired from the focus driver, and may set the corrected result as the value of the pixel focused on the subject. In the above description, the pixel values are replaced, but the present invention is not limited thereto. For example, the pixel value of the nearest focus may be multiplied by a coefficient to obtain a weighted sum.

Furthermore, a result of applying correction for removing flare only from commonly used image information to imaging information acquired from a focus driver may be used for correction processing. As illustrated in the drawing, in the captured image in the case of the closest focus, the area in which the flare occurs is smaller than that in the case of focusing on the subject. For this reason, by performing the interpolation processing on the captured image focused closest to which various interpolation processing can be more effectively applied, it is possible to perform highly accurate image correction even on the image information focused on the subject.

As another non-limiting example, a learned model may be used similarly to the first embodiment described above. For example, two imaging elements 2 having the same specification are used, one imaging element 2 directly captures an image of a subject, and the other imaging element 2 captures an image in an indirect state in which the display 4 and the cover glass 5 are mounted. The image information obtained by directly imaging the subject is information in a state where there is no influence of flare, and the image information obtained by indirectly imaging the subject is information including flare.

In the learning of the model, the image information included in the flare acquired above is input, and then the learning is performed so as to output the image information in a state where there is no influence of the flare. The model configuration and the learning method are arbitrary as in the above-described embodiment. In addition, in the present embodiment, information including flare in a case where focus is set to the closest distance may be used as the input information. In addition to the image information, the closest information may be input.

Furthermore, the information including the flare is not limited to only the closest focus, and the model may be trained such that deterioration images are generated by changing the focus to various focuses, and these deterioration images are input, and then image information from which the flare has been removed is output. Furthermore, the input image may be information acquired by a focus driver. Furthermore, a model that can input information regarding the optical system 100 such as focus information together through a focus driver may be formed.

Furthermore, the focus information may be output on the image side to be corrected. In this case, the teacher data may include information indicating focus information together with the corrected image.

The learned model can be learned in various forms using appropriate teacher data. In addition, the present invention is not limited to flare, and deterioration caused by the display 4 or the like may be handled in the same manner. An appropriate input image is input, and then the model learned in this manner outputs an image from which the flare has been removed. Furthermore, in a case where the input/output includes focus information, the focus information may be input/output.

As described above, the electronic device 1 according to the present embodiment can correct degradation of an image that can be reduced in area by focusing on the display 4 or the cover glass 5, such as flare, by a rule-based or learning-based method.

### Third Embodiment

In the present embodiment, an example of image correction in an electronic device 1 using a gyro sensor 110 will be described. A gyro sensor 110 is, for example, a sensor used for camera shake correction.

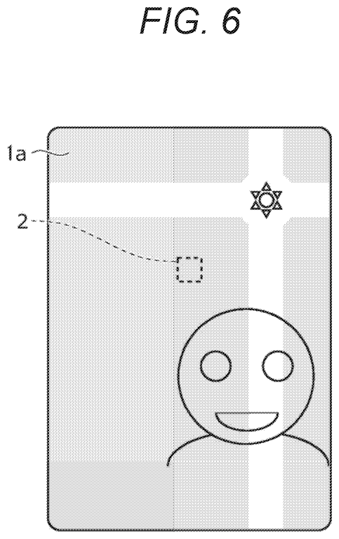

FIG. 6 is a diagram illustrating an example of image information captured in a state where flare occurs. For example, a flare overlaps a part of a face, and a pixel value is saturated in the overlapping region. Such an image is corrected on the basis of the output from the gyro sensor 110.

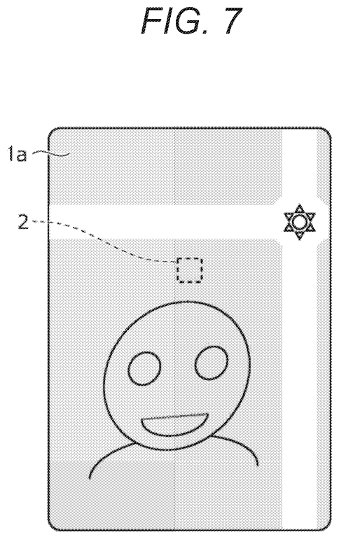

FIG. 7 illustrates an image whose angle is shifted from that in FIG. 6 due to camera shake or the like. In FIG. 7, for example, the flare region with respect to the face is relatively changed, and a region where the subject and the flare overlap is different from the case illustrated in FIG. 6.

A first processing circuit 104 corrects the image information illustrated in FIG. 6 on the basis of the deviation. As an example, the first processing circuit 104 calculates a change in angle from FIG. 6 to FIG. 7 from the output signal of the gyro sensor 110. Subsequently, the first processing circuit 104 associates common points or regions in each piece of image information on the basis of the deviation in angle.

This association may be performed, for example, by calculation between the world coordinates and the camera coordinates according to an internal parameter and an external parameter of the camera. Furthermore, the influence of various corrections such as lens distortion correction and various aberration corrections may be added.

The first processing circuit 104 may associate only the image of FIG. 7 with the image of FIG. 6, or as another example, may associate one or a plurality of other images in addition to the image of FIG. 7. In a case where three or more images are associated, the first processing circuit 104 stores, for example, the acquired images of the plurality of frames and the gyro signal for each of the images of the plurality of frames in the storage area in association with each other.

The first processing circuit 104 executes correction processing on the flare occurrence region in FIG. 6 by various interpolation methods. With this correction processing, it is possible to interpolate the information of the saturated region in FIG. 6 from the information captured at another angle.

Of course, also in the present embodiment, a learned model may be used for correction. As in the second embodiment described above, learning is executed so as to output image information captured in a state where the flare does not occur in the model on the basis of information captured in a state where the flare occurs and the gyro signal acquired from the gyro sensor 110.

As described above, according to the present embodiment, it is possible to correct image information in a state where flare or the like occurs on the basis of the gyro signal output from the gyro sensor 110. In general, the angle of the imaging surface of the imaging element 2 is deviated due to camera shake or the like, whereby an acquired image is distorted. Due to this distortion, it is often difficult to implement pattern matching in images of a plurality of frames. Even in such a case, according to the present embodiment, it is possible to appropriately realize the correction processing of the image information.

Note that in the above description, the output of the gyro sensor 110 is used, but in addition to this, the output from the acceleration sensor may be used. In this case, for example, the image information can be associated as absolute coordinates in the world coordinates.

### Fourth Embodiment

The example of using the output of the gyro sensor 110 is not limited to the above-described flare correction. The gyro sensor 110 can also be used to correct image degradation caused by display on the display 4 or the like.

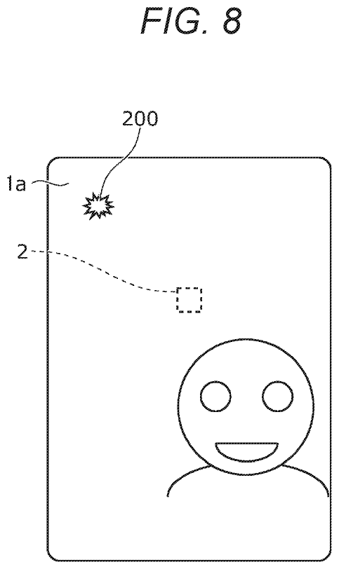

FIG. 8 is a diagram illustrating an example of image information captured by an imaging element 2. The flare may or may not occur. For example, as illustrated in FIG. 8, the imaging element 2 acquires some deterioration information 200 in an upper left region of the image.

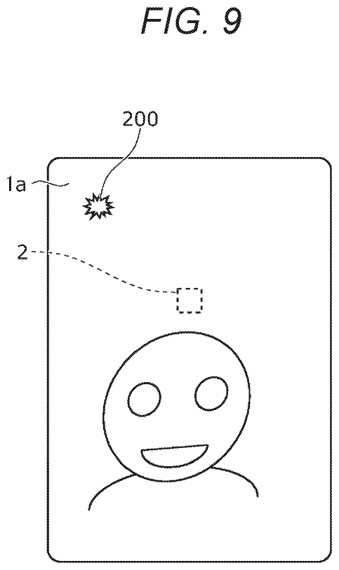

FIG. 9 is a diagram illustrating an example of image information captured by the imaging element 2 at different angles due to camera shake or the like. Also in FIG. 9, similarly to FIG. 8, in the imaging element 2, deterioration information 200 is imaged in an upper left region of the image. The deterioration information 200 may be the same as that in the case of FIG. 8. Here, the term “identical” is not limited to being strictly identical, and may include a slight difference in pixel value or the like.

In a case where such a plurality of pieces of image information is acquired, since the deterioration information 200 is captured regardless of the angle, a first processing circuit 104 determines that the deterioration information 200 is deterioration of the image due to processing inside an electronic device 1. As in the above-described third embodiment, the first processing circuit 104 corrects the information of the pixel value in the region of the deterioration information 200 in the corrected image on the basis of a gyro signal output from the gyro sensor 110.

For example, in a case where there is some display on the display 4, if the imaging element 2 is arranged so as not to change a relative position and posture with respect to a display surface in the electronic device 1, the deterioration caused by this display occurs in the same manner in a predetermined area regardless of the signal output from the gyro sensor 110.

From this, the first processing circuit 104 can determine that the deterioration information 200 occurring at the same position and the same size despite the occurrence of the hand shaking is deterioration caused by the display signal or other deterioration caused by the inside of the electronic device 1. Note that the first processing circuit 104 can further determine whether or not the deterioration information is caused by the display signal on the basis of the output from the display driver 106, or can determine whether or not the deterioration information is caused by the output from the display driver 106 and the output from the gyro sensor 110 in combination. After the determination, the first processing circuit 104 corrects the value of the pixel appropriately overlapping the deterioration information on the basis of the image information having different posture information of one or more other frames.

As described above, the degradation caused by the display signal can be corrected using the output signal from the gyro sensor 110.

In summary, in the third embodiment and the fourth embodiment, it is possible to estimate a positional relationship between an external subject and the imaging element 2 on the basis of the gyro information output from the gyro sensor 110, and correct a pixel (for example, a pixel that is saturated) for which an accurate pixel value cannot be acquired in a single frame from a change in image information of one or a plurality of frames along a time series.

In this manner, the gyro information in the electronic device 1 is acquired and a change in output between the gyro information and the image information acquired from the imaging element 2 in a time axis direction is captured, so that the first processing circuit 104 can realize correction processing of the image information.

### Fifth Embodiment

In the above-described embodiment, the case where the imaging element 2 is fixed in the electronic device 1 has been described, but the correction processing can be similarly executed even in a case where the imaging element 2 has some play for camera shake correction or the like.

For example, in a case where the imaging element 2 translates in the electronic device 1 and/or the pitch angle, the roll angle, and the yaw angle with respect to the electronic device 1 are variable, the first processing circuit 104 can correct the image information.

In a case where a deviation occurs in the image information between the plurality of frames due to the parallel movement, the imaging element 2 acquires the image information in a state where a relative position with respect to the display 4 or the like is different. The image degradation caused by the internal configuration of the electronic device 1 such as flare occurs in different regions on the basis of the parallel movement of the imaging element 2. Therefore, the pixel value saturated in the image information to be corrected can be interpolated and corrected from the pixel values of other frames.

The correction method may be similar to any of the embodiments described above. A similar method can be adopted also in the case of using the learning model. For example, learning is performed using an image that is not deteriorated in the imaging element 2 in which the display 4 or the like is not arranged and an image that is deteriorated by the display 4 or the like as training data, so that it is possible to form a model that outputs a corrected image when a deterioration image is input. In the present embodiment, a distance (sensor shift amount) of parallel movement may be input as input data.

In a case where a deviation occurs in image information between a plurality of frames due to the posture, the imaging element 2 acquires image information in a state where a relative posture with respect to the display 4 or the like is different. As in the case of the parallel movement, image degradation caused by the internal configuration of the electronic device 1 such as flare occurs in different regions on the basis of a change in the posture of the imaging element 2. Therefore, the image information can be corrected by various methods similarly to the above-described embodiments.

In the case of using the learned model, appropriate learning is performed in the same manner as described above, so that information regarding the posture, for example, at least one of the pitch angle, the roll angle, and the yaw angle may be input together with the input image.

As described above, according to the present embodiment, the image information can be corrected on the basis of the information of the relative position or the relative posture of the imaging element 2 in the electronic device 1.

Note that the acquisition of the relative position or the relative posture of the imaging element 2 may be executed on the basis of outputs from various drivers and various sensors.

Furthermore, at least a part of the optical system 100 may be arranged so as to be able to change the relative position or the relative posture together with the imaging element 2.

### Sixth Embodiment

In each of the above-described embodiments, the processing of correcting the image information on the basis of information acquired from various drivers or various sensors has been described. The correction processing mainly copes with image degradation caused by the internal configuration of the electronic device 1 such as flare. In addition, other information may be further corrected.

The first processing circuit 104 may execute at least one of automatic white balance control, automatic exposure control, and automatic focus control on the basis of the image information corrected in each of the above-described embodiments. The correction processing is performed by the first processing circuit 104, so that it is possible to reduce or remove the degradation information caused by the flare and the diffraction in the display 4. Therefore, the first processing circuit 104 can further acquire more accurate image information by executing various correction processing (while balance control, exposure control, or focus control) as described above using the image information from which the deterioration information has been reduced or removed.

Furthermore, in the processing such as flare removal in each of the above-described embodiments, the first processing circuit 104 may also execute correction processing regarding color information. The first processing circuit 104 can also use the data (including time-series data) acquired in each of the above-described embodiments in the linear matrix processing or the color conversion processing (signal format conversion processing).

For example, in a pixel that acquires information on a region where flare has occurred, an error regarding a color such as a false color in addition to saturation of a pixel value often occurs. It is also possible to correct the deterioration related to the color using information of other frames or the like on the basis of the flare occurrence situation or the like.

Therefore, the first processing circuit 104 may determine whether or not flare has occurred in addition to the correction processing in each of the above-described embodiments. This determination may be made, for example, under a condition that saturation occurs in a predetermined number or more of pixels, there is a predetermined number or more of saturated pixels in a region belonging to a rectangle in the image information, or the like.

In addition, clustering of whether or not flare has occurred may be performed using the learned model. In this case, the learned model may be learned so as to output that flare has occurred for the image information in which flare has occurred using the image information in which no flare has occurred and the image information in which flare has occurred as training data.

### Example of Processing

A non-limiting example of processing related to the present disclosure in the electronic device 1 will be described.

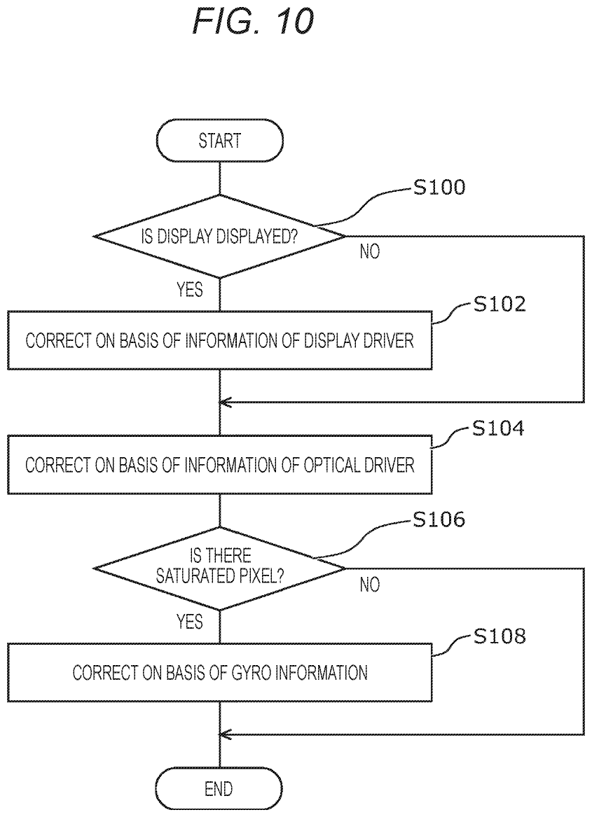

FIG. 10 is a flowchart illustrating image degradation correction processing caused by the internal configuration of the electronic device 1 of first processing circuit 104 as a non-limiting example. This flowchart illustrates the correction processing according to each of the above-described embodiments, and before and after this processing, preparation for image capturing by the imaging element 2 and processing and output processing of image information after being processed by the imaging element 2 are arbitrarily executed.

First, the first processing circuit 104 determines whether or not a display is displayed on the display 4 (S100). This determination is performed, for example, on the basis of whether or not a display signal is output from the display driver 106 to the display 4.

In a case where there is a display on the display 4 (S100: YES), the first processing circuit 104 executes deterioration correction processing based on light emitted by the light emitting element on the basis of the display signal acquired from the display driver 106 (S102). With this correction, for example, deterioration caused by a display signal displayed on the display 4 can be corrected.

In a case where there is a display on the display 4, following the processing of S102, and also in a case where there is no display on the display 4 (S100: NO), the first processing circuit 104 executes correction based on the information of the optical driver 108 without performing the processing of S102 (S104). For example, the electronic device 1 controls the optical system 100 through a focus driver for imaging, and the imaging element 2 captures an image. The first processing circuit 104 corrects the imaged information on the basis of the focus information acquired from the focus driver. With this correction, for example, deterioration such as reflection of flare can be corrected.

Next, the first processing circuit 104 determines whether or not there is a saturated pixel (S106). The first processing circuit 104 may determine whether or not there is a saturated pixel depending on whether or not there is a pixel whose pixel value is the maximum value.

In a case where there is a saturated pixel (S106: YES), the first processing circuit 104 executes correction of the image information based on the gyro information (S108). The first processing circuit 104 specifies a subject using gyro information by, for example, a hand shake of the user, an intentional operation, or the like, and interpolates a pixel value of a saturated pixel from information of another frame.

After the processing of S106 or in a case where there is no saturated pixel (S106: NO), the first processing circuit 104 finishes the correction processing according to the present disclosure.

Note that FIG. 10 is illustrated as a non-limiting example, and it is not necessary to execute all the processing, and as described in the above-described embodiments, at least one correction processing of S102, S104, or S106 may be executed. In addition, other corrections such as color correction and focus correction are not excluded. For example, the first processing circuit 104 may execute only the correction processing of S104 as the correction of the flare, may execute only the correction processing of S106, or may execute both correction processing of reducing the flare region by the correction of S104 and then executing the correction processing of S106.

Note that, in each of the above-described embodiments, the first processing circuit 104 performs the correction processing, but the present invention is not limited thereto. For example, if the data transfer speed can be sufficiently secured, the second processing circuit 114 or another processing circuit may execute the image signal correction processing. In this case, the acquisition of the time-series data from the sensor or the like may be executed by the first processing circuit 104 or may be executed by the second processing circuit 114 or the like.

As described in the foregoing embodiments, according to some embodiments of the present disclosure, it is possible to acquire a shape change of information regarding an image signal over time and correct image information on the basis of the shape change. This shape change can be grasped by acquiring a plurality of images in the time axis direction. The first processing circuit 104 can also determine the correction content by appropriately processing information from the imaging element 2 and a change in shape or state acquired from various drivers or sensors. For example, the image information of another frame focused on the subject may be corrected on the basis of the image information acquired by the proximity focus.

The embodiments described above may have the following forms.

(1)

An electronic device, including:
a display surface that displays information on a basis of light emitted from a light emitting element;
an imaging element disposed on an opposite side of the display surface; and
a processing circuit that processes a signal output from the imaging element, in which
the processing circuit
acquires data not caused by the imaging element, and
corrects an image signal light-received and output by the imaging element using the acquired data not caused by the imaging element.
   (2)

The electronic device according to (1), in which
the data not caused by the imaging element is data caused by the display surface.
   (3)

The electronic device according to (2), in which
the data caused by the display surface is caused by light emitted from the light emitting element.
   (4)

The electronic device according to (3), in which
the data caused by the display surface is caused by at least one of diffraction or reflection on the display surface or light emitted from the light emitting element and directly reaching the imaging element.
   (5)

The electronic device according to any one of (2) to (4), in which
the data caused by the display surface is caused by light incident on the display surface.
   (6)

The electronic device according to (5), in which
the data caused by the display surface is caused by flare of light incident from the outside on the display surface.
   (7)

The electronic device according to any one of (1) to (6), further including
a focus driver that controls a focus, in which
the processing circuit
corrects the image signal on a basis of information acquired by the focus driver.
   (8)

The electronic device according to (7), in which
the processing circuit
acquires imaging information in proximity focus acquired by the focus driver, and
corrects the image signal with what is displayed in proximity to be corrected on a basis of imaging information in the proximity focus.
   (9)

The electronic device according to (8), in which
the processing circuit
corrects the image information focused on an external subject on the basis of imaging information in the proximity focus.
   (10)

The electronic device according to any one of (2) to (9), in which
the processing circuit
acquires a display signal to be displayed through the display surface, and
corrects the image signal on the basis of the display signal.
   (11)

The electronic device according to (10), in which
the processing circuit
acquires the display signal from a display driver that controls the light emitting element, or acquires the display signal input from an outside to correct the image signal.
   (12)

The electronic device according to (10) or (11), in which
the processing circuit
corrects the image signal on the basis of a signal obtained by reducing resolution of the display signal.
   (13)

The electronic device according to any one of (2) to (12), further including
a gyro sensor; in which
the processing circuit
corrects the image signal on a basis of a gyro signal output from the gyro sensor.
   (14)

The electronic device according to (13), in which
the processing circuit
uses an image without camera shake as a display signal on the basis of the gyro signal, and
corrects the image signal on the basis of the display signal.
   (15)

The electronic device according to (13) or (14), in which
the processing circuit
estimates a positional relationship between an external subject and the imaging element on a basis of the gyro signal, and
corrects the image signal from a change in data acquired by the imaging element for a pixel for which an accurate pixel value has not been acquired in a single frame.
   (16)

The electronic device according to (15), in which
a pixel in which the accurate pixel value cannot be acquired is a pixel in which a signal output from the pixel is saturated.
   (17)

The electronic device according to any one of (2) to (16), in which
the correction processing includes correction processing related to a color of the image signal.
   (18)

The electronic device according to (17), in which
the color correction processing is correction processing at a linear matrix application timing, correction processing at a conversion timing to a YUV signal, or correction processing in color conversion using an LUT.
   (19)

The electronic device according to any one of (2) to (18), in which
the correction further includes correction processing related to at least one of automatic white balance control, automatic exposure control, and automatic focus control.
   (20)

The electronic device according to any one of (2) to (19), in which
the imaging element is disposed
so that a positional relationship with the display surface is changed, and
the processing circuit
corrects the image signal on a basis of the positional relationship between the display surface and the imaging element along a time series.
   (21)

The electronic device according to any one of (1) to (20), in which
the processing circuit
acquires a shape change in the image signal with a lapse of time, and
corrects the image information on a basis of the shape change.
   (22)

The electronic device according to any one of (1) to (21), in which
the processing circuit
corrects the image information using a learned model.
   (23)

The electronic device according to (22), in which
the learned model is a model learned using a display signal and the image signal as teacher data.

Aspects of the present disclosure are not limited to the above-described embodiments, and include various conceivable modifications. The effects of the present disclosure are not limited to the above-described contents. The components in each of the embodiments may be appropriately combined and applied. That is, various additions, modifications, and partial deletions can be made without departing from the conceptual idea and gist of the present disclosure derived from the contents defined in the claims and equivalents and the like thereof.

### REFERENCE SIGNS LIST

1 Electronic device
2 Imaging element
3 Component layer
4 Display
5 Cover glass
100 Optical system
102 Light receiving unit
104 First processing circuit
106 Display driver
108 Optical driver
110 Gyro sensor
112 Interface
114 Second processing circuit

1. An electronic device, comprising:
a display surface that displays information on a basis of light emitted from a light emitting element;
an imaging element disposed on an opposite side of the display surface; and
a processing circuit that processes a signal output from the imaging element, wherein
the processing circuit
acquires data not caused by the imaging element, and
corrects an image signal light-received and output by the imaging element using the acquired data not caused by the imaging element.

2. The electronic device according to claim 1, wherein
the data not caused by the imaging element is data caused by the display surface.

3. The electronic device according to claim 2, wherein
the data caused by the display surface is caused by light emitted from the light emitting element.

4. The electronic device according to claim 3, wherein
the data caused by the display surface is caused by at least one of diffraction or reflection on the display surface or light emitted from the light emitting element and directly reaching the imaging element.

5. The electronic device according to claim 2, wherein
the data caused by the display surface is caused by light incident on the display surface.

6. The electronic device according to claim 5, wherein
the data caused by the display surface is caused by flare of light incident from an outside on the display surface.

7. The electronic device according to claim 1, further comprising
a focus driver that controls a focus, wherein
the processing circuit
corrects the image signal on a basis of information acquired by the focus driver.

8. The electronic device according to claim 7, wherein
the processing circuit
acquires imaging information in proximity focus acquired by the focus driver, and
corrects the image signal with what is displayed in proximity to be corrected on a basis of imaging information in the proximity focus.

9. The electronic device according to claim 2, wherein
the processing circuit
acquires a display signal to be displayed through the display surface, and
corrects the image signal on a basis of the display signal.

10. The electronic device according to claim 9, wherein
the processing circuit
acquires the display signal from a display driver that controls the light emitting element, or acquires the display signal input from an outside to correct the image signal.

11. The electronic device according to claim 9, wherein
the processing circuit
corrects the image signal on a basis of a signal obtained by reducing resolution of the display signal.

12. The electronic device according to claim 2, further comprising
a gyro sensor; wherein
the processing circuit
corrects the image signal on a basis of a gyro signal output from the gyro sensor.

13. The electronic device according to claim 12, wherein
the processing circuit
estimates a positional relationship between an external subject and the imaging element on a basis of the gyro signal, and
corrects the image signal from a change in data acquired by the imaging element for a pixel for which an accurate pixel value has not been acquired in a single frame.

14. The electronic device according to claim 2, wherein
the correction includes correction processing related to a color of the image signal.

15. The electronic device according to claim 14, wherein
the color correction processing is correction processing at a linear matrix application timing, correction processing at a conversion timing to a YUV signal, or correction processing in color conversion using an LUT.

16. The electronic device according to claim 2, wherein
the correction further includes correction processing related to at least one of automatic white balance control, automatic exposure control, and automatic focus control.

17. The electronic device according to claim 2, wherein
the imaging element is disposed
so that a positional relationship with the display surface is changed, and
the processing circuit
corrects the image signal on a basis of the positional relationship between the display surface and the imaging element along a time series.

18. The electronic device according to claim 1, wherein
the processing circuit
acquires a shape change in the image signal with a lapse of time, and
corrects the image signal on a basis of the shape change.

19. The electronic device according to claim 1, wherein
the processing circuit
corrects the image signal using a learned model.

20. The electronic device according to claim 19, wherein
the learned model is a model learned using a display signal and the image signal as teacher data.
